(19) United States
(12) Patent Application Publication
(10) Pub. No.: US 2018/0082262 A1
(43) Pub. Date: Mar. 22, 2018

(54) OPTIMIZE MEETING BASED ON ORGANIZER RATING

(71) Applicant: MICROSOFT TECHNOLOGY LICENSING, LLC, Redmond, WA (US)

(72) Inventor: Mohit Singh Kathuria, Sammamish, WA (US)

(73) Assignee: MICROSOFT TECHNOLOGY LICENSING, LLC, Redmond, WA (US)

(21) Appl. No.: 15/267,154

(22) Filed: Sep. 16, 2016

(51) Int. Cl. G06Q 10/10; G06Q 10/06

(52) U.S. Cl. CPC G06Q 10/1095; G06Q 10/06393

(57) ABSTRACT

Variety of approaches to optimize a meeting based on an organizer rating are described. A productivity service initiates operations to optimize a meeting by transmitting a request to a meeting attended to rate a meeting organizer for an evaluation of a usefulness of a meeting. A usefulness value associated with the meeting is received from the meeting attendee. A meeting score is computed from the usefulness value. The meeting score is stored in an association with the meeting organizer.

### BACKGROUND

Information exchange have changed processes associated work and personal environments. Automation and improvements in processes have expanded scope of capabilities offered for personal and business consumption. With the development of faster and smaller electronics, execution of mass processes at cloud systems have become feasible. Indeed, applications provided by data centers, data warehouses, data workstations have become common features in modem personal and work environments. Such systems execute a wide variety of applications ranging from enterprise resource management applications to personal productivity tools. Many such applications manage collaboration and communication between users. Collaboration and communication consume significant resources and performance at a promise of improved user productivity.

Improved collaboration techniques are becoming evermore important as communication complexity increases across the computer industry. Variety of techniques are necessary to setup meetings for collaboration sessions, to facilitate the meetings, and (ultimately) to empower collaboration during meetings. There are currently significant gaps when assessing a meeting quality during creation and subsequent execution of meetings. Lack of relevant evaluation methods lead to poor management of timed resources when engaging collaboration with meetings.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an optimization of a meeting based on an organizer rating. A productivity service, according to embodiments, may initiate operations to optimize the meeting by transmitting a request to a meeting attendee to rate a meeting organizer for an evaluation of a usefulness of a meeting. A usefulness value associated with the meeting may be received from the meeting attendee. Next, a meeting score may be computed from the usefulness value. The meeting score may further be stored in an association with the meeting organizer.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of optimizing a meeting based on an organizer rating, according to embodiments;

FIG. 2 is a display diagram illustrating example components of a productivity service that optimizes a meeting based on an organizer rating, according to embodiments;

FIG. 3 is a display diagram illustrating components of a scheme to optimize a meeting based on an organizer rating, according to embodiments;

FIG. 4 is a display diagram illustrating a meeting invitation highlighting a meeting score associated with the meeting organizer, according to embodiments;

FIG. 5 is a simplified networked environment, where a system according to embodiments may be implemented;

FIG. 6 is a block diagram of an example computing device, which may be used to optimize a meeting based on an organizer rating, according to embodiments; and

FIG. 7 is a logic flow diagram illustrating a process for optimizing a meeting based on an organizer rating, according to embodiments.

### DETAILED DESCRIPTION

As briefly described above, a productivity service may optimize a meeting based on an organizer rating. In an example scenario, the productivity service may transmit a request to a meeting attendee to rate a meeting organizer for an evaluation of a usefulness of a meeting. A meeting is a time resource intensive activity that consumes time resources of an meeting attendee. As such, the meeting attendee may desire to know whether a meeting organizer creates a meeting that may be beneficial to the meeting attendee. An evaluation of the meeting organizer may be performed based on past rankings by meeting attendees of meetings organized by the meeting attendee.

In an example scenario, the productivity service, may receive a usefulness value associated with the meeting from the meeting attendee. The usefulness value may be selected from a value range provided by the productivity service. A meeting score may be computed from the usefulness value and other usefulness value(s) provided by other meeting attendee(s). For example, the meeting score may computed by averaging the usefulness value and the other usefulness value(s). The meeting score may be stored in an association with the meeting organizer. Furthermore, the meeting score may be provided with a future meeting invitation created by the meeting organizer. The meeting score may be provided with a scale (matching the value range) to inform the future meeting invitee of a usefulness of the future meeting.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” be a combination of software and hardware components to optimize a meeting based on an organizer rating. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display, a non-visual display (for impaired users as an example), and/or other user experience associated with an application or service through which a user interacts with the application or service. A user action refers to an interaction between a user and a user experience of an application or a user experience provided by a service that includes touch input, gesture input, voice command, eye tracking, gyroscopic input, pen input, mouse input, and/or keyboards input, among others. An application programming interface (API) may be a set of routines, protocols, and tools for an application or service that enable the application or service to interact or communicate with one or more other applications and services managed by separate entities.

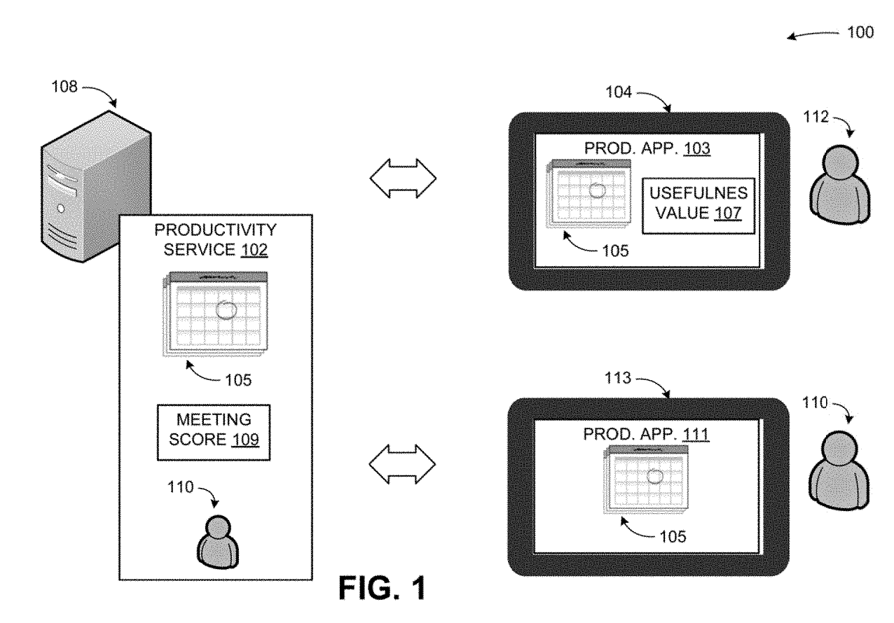

FIG. 1 is a conceptual diagram illustrating examples of optimizing a meeting based on an organizer rating, according to embodiments.

In a diagram 100, a physical server 108 may execute a productivity service 102. The physical server 108 may include a physical server providing service(s) and/or application(s) to client devices. A service may include an application performing operations in relation to a client application and/or a subscriber, among others. The physical server 108 may include and/or is part of a workstation, a data warehouse, a data center, and/or a cloud based distributed computing source, among others.

The physical server 108 may execute the productivity service 102. The productivity service 102 may initiate operations to optimize a meeting by transmitting a request to a meeting attendee 112 to rate a meeting organizer 110 for an evaluation of a usefulness of a meeting 105. The request may include a value range from which the meeting attendee 112 may select a usefulness value 107 associated with the meeting 105. The value range may include a variety of values such as 1-100, 0-100, 1-10, 0-10, 1-5, and/or 0-5, among others. A descriptive range may also be provided instead of a value range. An example of the descriptive range may include descriptions from valuable to useless, among others associated with the meeting 105. The productivity service 102 may convert the descriptive range to a value range.

In an example scenario, a meeting organizer 110 may request creation of a meeting 105 by interacting with a productivity application 111 executed by a client device 113. The productivity service 102 may either create the meeting 105 upon receiving the request from the productivity application 111 or detect the creation of the meeting 105 by interacting with the productivity application 111. Upon a conclusion of the meeting 105 (such as an expiration of a duration of the meeting 105) the productivity service 102 may transmit the request to evaluate the meeting organizer 110 to the meeting attendee 112 (through a productivity application 103 executed on a client device 104). The meeting attendee 112 may interact with the productivity application 103 to select the usefulness value 107 for the meeting 105. The productivity application 103 and/or the productivity application 111 may be client interfaces of the productivity service 102.

The productivity service 102 may receive the usefulness value 107 from the meeting attendee 112. A meeting score may be computed from the usefulness value 107 by averaging the usefulness value 107 with other usefulness value(s) received from other meeting attendee(s). The other meeting attendee(s) may rate the meeting 105 or other meeting(s) organized by the meeting organizer 110. The meeting score 109 may be stored in an association with the meeting organizer 110. The productivity service 102 may provide the meeting score 109 (and a scale matching the value range) along with a new meeting invitation generated by the meeting organizer 110 to inform a new meeting attendee regarding a usefulness of the new meeting.

The physical server 108 may communicate with the client device 104 and/or the client device 113 through a network. The network may provide wired or wireless communications between network nodes such as the client device 104, the client device 113, and/or the physical server 108, among others. Previous example(s) to optimize a meeting based on an organizer rating are not provided in a limiting sense. Alternatively, the productivity service 102 may compute the meeting score 109 as a desktop application, a workstation application, and/or a server application, among others. The productivity application 103 and the productivity application 111 may also include a client interface of the productivity service 102.

The meeting attendee 112 and the meeting organizer 110 may interact with the productivity application 103 and the productivity application 111, respectively, with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the physical server 108, the productivity service 102, embodiments are not limited to these components or system configurations and can be implemented with other system configuration employing fewer or additional components.

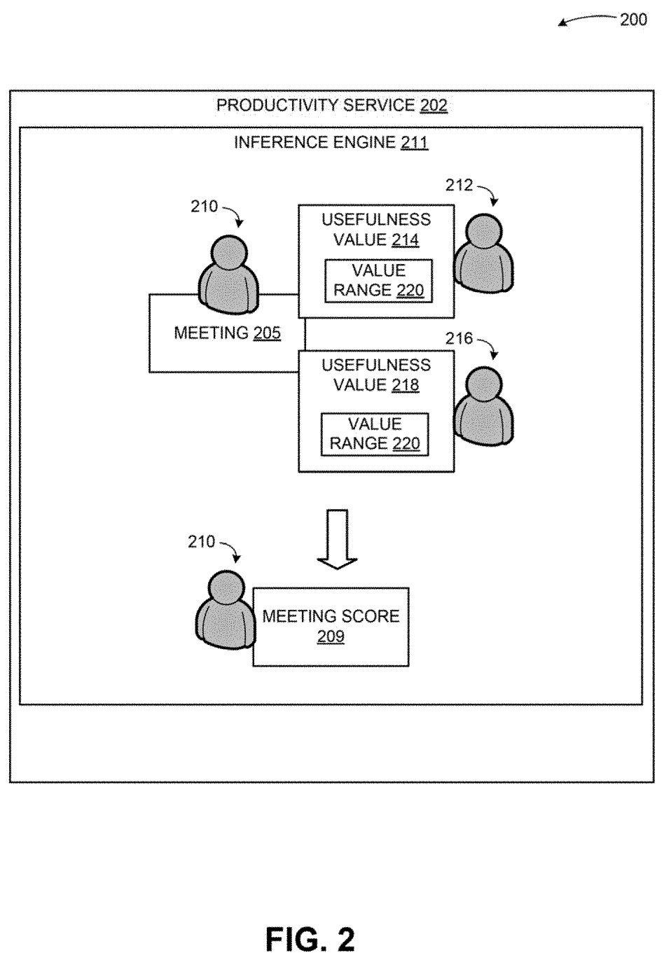

FIG. 2 is a display diagram illustrating example components of a productivity service that optimize a meeting based on an organizer rating, according to embodiments.

In a diagram 200, an inference engine 211 of a productivity service 202 may transmit a request to a meeting attendee 212 to evaluate a usefulness of a meeting 205 organized by a meeting organizer 210. The request may include a value range 220 from which the meeting attendee may select a usefulness value 214 associated with the meeting 205. The value range 220 may be a number range including a variety of numbers such as (but not exclusive to) 0-10, 1-10, 0-5, and/or 1-5, among others.

The inference engine 211 may also transmit other request(s) to other meeting attendee(s) (such as the meeting attendee 216) to evaluate a usefulness of the meeting 205. Other request may also restrict a usefulness value 218 to the value range 220 to normalize a computation of a meeting score 209 from the usefulness values (214 and 218). Upon receiving the usefulness values (214 and 218) from the meeting attendees (212 and 216), the inference engine may compute the meeting score 209 by averaging the usefulness values (214 and 218). Furthermore, the meeting score 209 may be stored in association with the meeting organizer 210. The meeting score 209 (and a scale matching the value range 220) may be provided along with a new meeting invitation (created by the meeting organizer 210) to quantify a usefulness of the new meeting and to inform a potential meeting attendee who is considering whether to attend the new meeting.

A stored value for the meeting score 209 may be re-computed upon receiving other usefulness value(s) associated with the meeting 205 (from other meeting attendee(s)) after a computation of the meeting score 209. The usefulness values (214 and 218) may be averaged with the other usefulness value(s). A re-computed meeting score may be used to update the stored value of the meeting score 209.

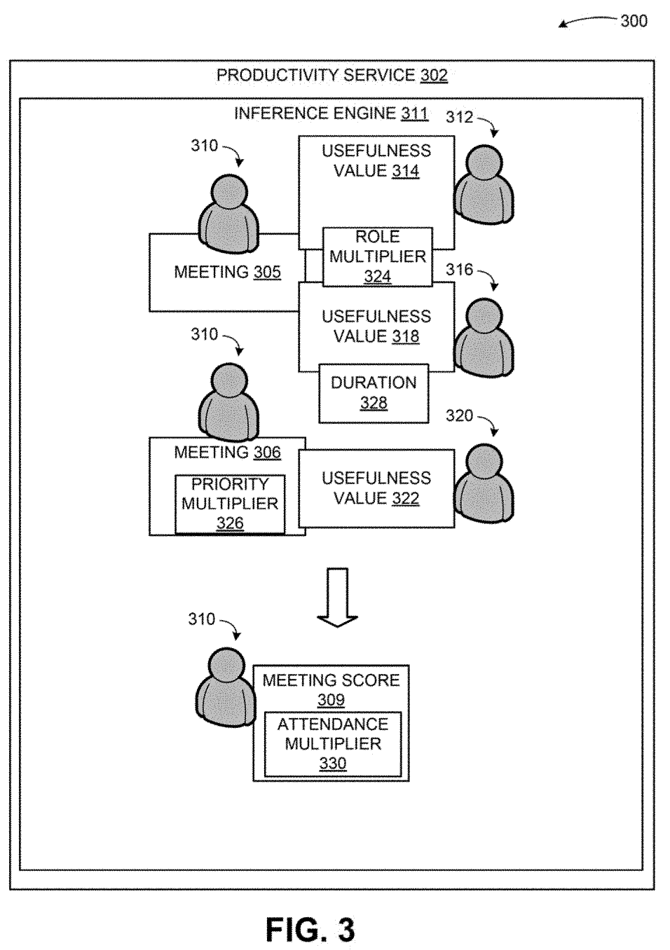

FIG. 3 is a display diagram illustrating components of a scheme to optimize a meeting based on an organizer rating, according to embodiments.

In a diagram 300, an inference engine 311 of a productivity service 302 may transmit requests and receive usefulness, values (314 and 318) associated with a meeting 305 from meeting attendees (312 and 316). The usefulness values (314 and 318) may be selected from a value range provided with the requests. A meeting score 309 may be computed by averaging the usefulness values (314 and 318) and other usefulness value(s) such as a usefulness value 322 received from a meeting attendee 320. The meeting attendee 320 may have attended another meeting organized by the meeting organizer 310 such as a meeting 306. Usefulness value(s)) associated with other meeting(s) organized by the meeting organizer 310 may also be considered when computing the meeting score 309. As such, the inference engine 311 may compute the meeting score by averaging the usefulness values (314 and 318) associated with the meeting 305 and the usefulness value 322 associated with the meeting 306. The meeting score 309 may be stored in an association with the meeting organizer 310.

In an example scenario, a meeting priority level associated with the meeting 306 may be identified. The meeting priority level may be an attribute of the meeting 306 that is set by the meeting organizer 310. Alternatively, the meeting priority level may be an attribute of the meeting 306 that is automatically configured based on properties of the meeting such as identity of the meeting attendee(s), organizational role(s) associated with the meeting attendee(s), a timing of the meeting 306, a location of the meeting 306, and/or a subject of the meeting 306, among others. The inference engine 311 may multiply the usefulness value 322 with a priority multiplier 326 associated with the meeting priority level.

For example, if the meeting 306 includes a high meeting priority level then the usefulness value 322 may be multiplied with a priority multiplier 326 that may produce an adjusted usefulness value that is higher than the usefulness value 322. Alternatively, if the meeting 306 includes a low meeting priority level then the usefulness value 322 may be multiplied with a priority multiplier 326 that may produce an adjusted usefulness value that is lower than the usefulness value 322. Furthermore, if the meeting 306 includes a medium meeting priority level then the usefulness value 322 may be multiplied with a priority multiplier 326 that may produce an adjusted usefulness value that is similar to the usefulness value 322. The adjusted usefulness value may be normalized to keep the adjusted usefulness value within the value range used to select the usefulness value 322. The normalized adjusted usefulness value may be used to compute (or re-compute) the meeting score 309.

In another example scenario, the inference engine 311 may identify an organization role of the meeting organizer 310 and/or the meeting attendees (312 and 316). The usefulness values (314 and 318) may be multiplied with a role multiplier 324 associated with the organizational role of the meeting organizer 310 and/or the meeting attendees (312 and 316) to produce adjusted usefulness values. The adjusted usefulness values may be normalized to keep the adjusted usefulness values within a value range used to select the usefulness values (314 and 318). The normalized adjusted usefulness values may be to compute (or re-compute) the meeting score 309.

For example, if the meeting organizer and/or the meeting attendees (312 and 316) include an organizational role such as a supervisory role, and/or an executive role, among others that are considered valuable then the usefulness values (314 and 318) may be multiplied with a role multiplier 324 that may produce higher adjusted usefulness values compared to the usefulness values (314 and 318). Alternatively, if the organizer and/or the meeting attendees (312 and 316) include an organizational role such as a subordinate role, and/or an co-worker role, among others that are considered moderate to undervalued then the usefulness values (314 and 318) may be multiplied with a role multiplier that may produce lower or equal adjusted usefulness values compared to the usefulness values (314 and 318).

Furthermore, the meeting score 309 may be adjusted with an attendance multiplier 330. A number of the meeting attendees (312 and 316) may be divided with a number of the meeting invitees to produce the attendance multiplier 330. The meeting score 309 may be updated by multiplying the meeting score 309 with the attendance multiplier 330.

For example, if the number of the meeting attendees (312 and 316) equals the number of the meeting invitees then the meeting score 309 keeps a previous value. However, if the number of the meeting attendees (312 and 316) is less than the meeting invitees then the meeting score 309 decreases. The inference engine 311 may apply the attendance multiplier 330 to evaluate a success of the meeting organizer 310 to induce meeting invitees to attend the meeting 305. Alternatively, the attendance multiplier 330 may be applied o a total number of meeting attendees associated with multiple meetings organized by the meeting organizer 310 compared to a total number of meeting invitees associated with the multiple meetings.

The inference engine 311 may monitor each usefulness value with a duration such as the duration 328 associated with the usefulness value 318. The duration 328 may include a time period (from a time when the usefulness value is received from the meeting attendee) in which the usefulness value is relevant. For example, upon an expiration of the duration 328, the usefulness value 318 may be removed and the meeting score 309 may be re-computed without the usefulness value 318. The duration 328 may be configured by the inference engine 311 or may be manually configurable. Furthermore, a group and/or an organization associated with the meeting organizer may be granted an access to the meeting score 309.

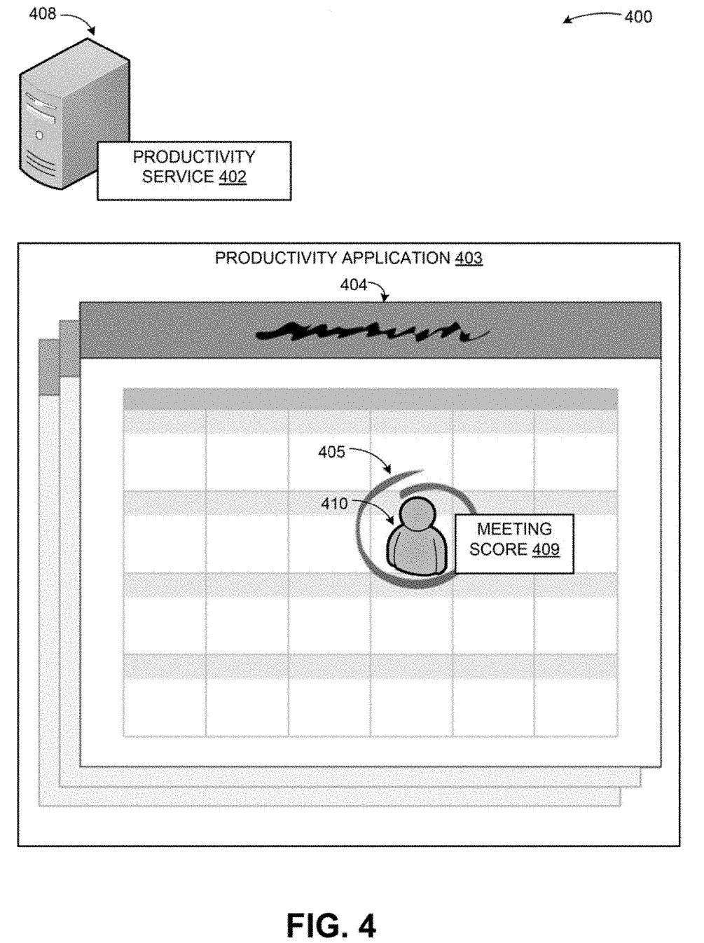

FIG. 4 is a display diagram illustrating a meeting invitation highlighting a meeting score associated with the meeting organizer, according to embodiments.

In a diagram 400, a productivity service 402 (executing in a physical server 408) may provide a productivity application 403. The productivity application 403 may render a meeting invitation 404 of a meeting 405. The meeting invitation 404 may designate a time and a location of the meeting 405. In addition, the productivity service 402 may provide a meeting score 409 associated with a meeting organizer 410 of the meeting 405 for display by the productivity application 403. The meeting score 409 may be computed based on usefulness value(s) associated with previous meeting(s) organized by the meeting organizer 410. The usefulness value(s) may be received from the meeting attendee(s) of the previous meeting(s). The productivity service 402 may also provide a scale used to evaluate the meeting score 409 for display by the productivity application 403. The productivity service 402 may inform a meeting invitee of a usefulness of the meeting 405 by allowing the meeting invitee to compare a location of the meeting score 409 in relation to the scale.

The productivity service 402 may also filter meeting invitee(s) of the meeting 405 based on a meeting score threshold associated with the meeting invitee(s). In an example scenario, the productivity service 402 may receive a request to generate the meeting 406 from the meeting organizer 410. The productivity service 402 may analyze a meeting invitee (identified by the meeting organizer 410) to identify a meeting score threshold associated with the meeting invitee. The meeting score threshold may be a property of the meeting invitee's user account. The productivity service 402 may detect the meeting score 409 associated with the meeting organizer 410 fail to exceed the meeting score threshold associated with the meeting invitee. In response, the meeting invitee may be excluded from the meeting invitation 404 of the meeting 405.

As discussed above, the productivity service may be employed to perform operations to automate optimization of a meeting based on an organizer rating. An increased user efficiency with the client interfaces of the productivity service 102 may occur as a result of computing a meeting score associated with a meeting organizer based on usefulness value(s) requested from meeting attendee(s). The meeting score may be provided with a new meeting to inform a meeting invitee of a usefulness of the new meeting. Additionally, computing the meeting score, by the productivity service 102, may reduce processor load, increase processing speed, conserve memory, and reduce network bandwidth usage.

Embodiments, as described herein, address a need that arises from a lack of efficiency to optimize a meeting based on an organizer rating. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Optimizing a meeting based on are organizer rating may be implemented in configurations employing fewer or additional components in applications and user interfaces. Furthermore, the example schema and components shown in FIG. 1 through 4 and their subcomponents may be implemented in a similar manner with other values using the principles described herein.

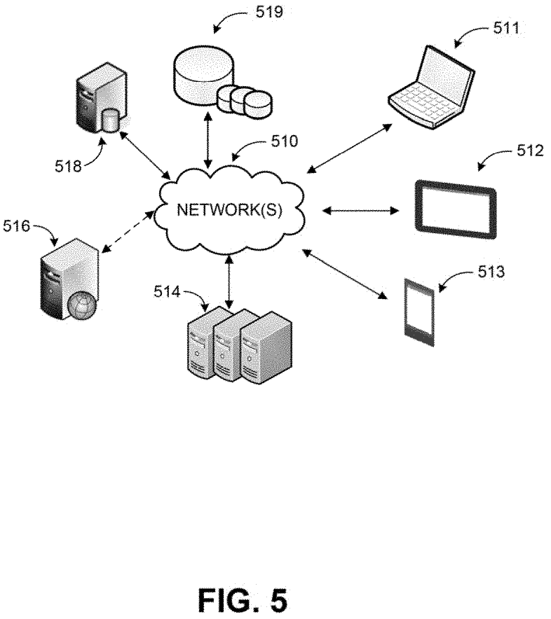

FIG. 5 is an example networked environment, where embodiments may be implemented. A productivity service configured to optimize a meeting based on an organizer rating may be implemented via software executed over one or more servers 514 such as a hosted service. The platform may communicate with client applications on individual computing devices such as a smart phone 513, a mobile computer 512, or desktop compute 511 (‘client devices’) through network(s) 510.

Client applications executed on any of the client devices 511-513 may facilitate communications via application(s) executed by servers 514, or on individual server 516. A productivity service may transmit a request to a meeting attendee to rate a meeting organizer for an evaluation of a usefulness of the meeting. The usefulness value associated with the meeting may be received from the meeting attendee. A meeting score may be computed from the usefulness value. The meeting score may be stored in an association with the meeting organizer. The productivity service may store data associated with the meeting in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to optimize a meeting based on an organizer rating. Furthermore, the networked environments discussed in FIG. 5 are for illustration purposes only. Embodiments are not limited to the example applications, modules, or processes.

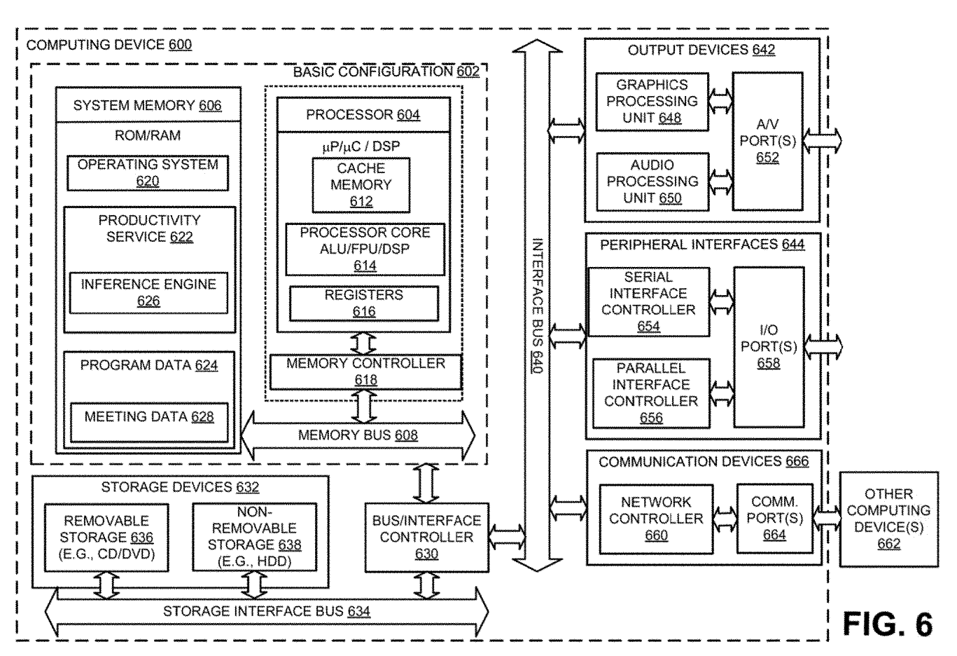

FIG. 6 is a block diagram of an example computing device, which may be used to optimize a meeting based on an organizer rating, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity service 622, and a program data 624. The productivity service 622 may include a component such as an inference engine 626. The inference engine 626 may execute the processes associated with the productivity service 622. The inference engine 626 may transmit a request to a meeting attendee to rate a meeting organizer for an evaluation of a usefulness of the meeting. A usefulness value associated with the meeting may be received from the meeting attendee. A meeting score may be computed from the usefulness value. The meeting score may be stored in an association with the meeting organizer.

Input to and output out of the productivity service 622 may be transmitted through a communication module associated with the computing device 600. An example of the communication module may include a communication device 666 that may be communicatively coupled to the computing device 600. The communication module may provide wired and/or wireless communication. The program data 624 may also include, among other data, meeting data 628, or the like, as described herein. The meeting data 628 may include a meeting score, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), d field programmable gate array (FPGA), a programmable logic device (PLD), and/or a free form logic on an integrated circuit (IC), among others.

Example embodiments may also include methods to optimize a meeting based on an organizer rating. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

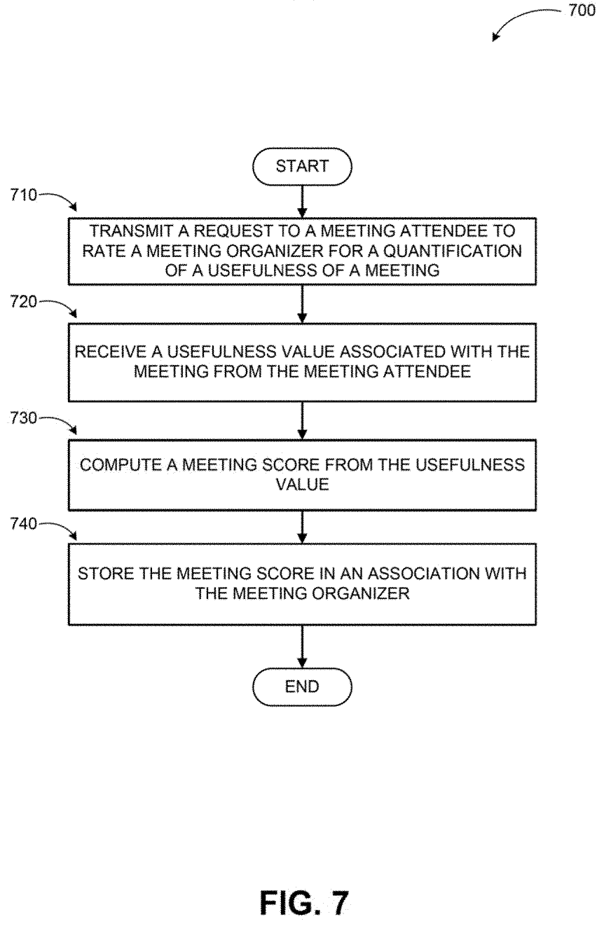

FIG. 7 is a logic flow diagram illustrating a process for optimizing a meeting based on an organizer rating, according to embodiments. Process 700 may be implemented on a computing device, such as the computing device 600 or another system.

Process 700 begins with operation 710, where the productivity service may transmit a request to a meeting attendee to rate a meeting organizer for an evaluation of a usefulness of the meeting. The request may include a value ramie from which the meeting attendee may select a usefulness value associated with the meeting. At operation 720, the productivity service may receive the usefulness value associated with the meeting from the meeting attendee. Other usefulness value(s) may also be received from other meeting attendee(s) of the meeting. Furthermore, other usefulness value(s) associated with other meeting(s) organized by the meeting organizer may also be used to compute a meeting score.

At operation 730, a meeting score may be computed form the usefulness value. For example, the usefulness value and other usefulness value(s) (associated with other meeting(s) organized by the meeting organizer) may be averaged to produce the meeting score. At operation 740, the meeting score may be stored in an association with the meeting organizer.

The operations included in process 700 is for illustration purposes. Optimizing a meeting based on an organizer rating may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples a physical server to optimize a meeting based on an organizer rating is described. The physical server includes a communication module configured to facilitate exchange of information associated with the meeting and other data with computing devices, a memory configured to store instructions associated with a productivity service, and a processor coupled to the memory and the communication module. The processor executes the productivity service in conjunction with the instructions stored in the memory. The productivity service includes an inference engine. The inference engine is configured to transmit, through the communication module, a request to a meeting attendee to rate a meeting organizer for an evaluation of a usefulness of the meeting, receive, through the communication module, a usefulness value associated with the meeting from the meeting attendee, compute a meeting score from the usefulness value, and store the meeting score in an association with the meeting organizer.

In other examples, the inference engine is further configured to transmit, through the communication module, other request to other meeting attendee to rate the meeting organizer for another evaluation of the usefulness of the meeting and receive, through the communication module, other usefulness value from the other meeting attendee. The inference engine is further configured to re-compute the meeting score by averaging the usefulness value and the other usefulness value and update a stored value of the meeting score with the re-computed meeting score. The inference engine is further configured to transmit, through the communication module, a new request to a new meeting attendee to rate the meeting organizer to evaluate another usefulness of a new meeting and receive, through the communication module, a new usefulness value from the new meeting attendee. The inference engine is further configured to re-compute the meeting score by averaging the usefulness value and the new usefulness value and update a stored value of the meeting score with the re-computed meeting score.

In further examples, the inference engine is further configured to provide a value range within the request to the meeting attendee from which to select the usefulness value. The inference engine is further configured to identify a meeting priority level associated with the meeting, multiply the usefulness value with a priority multiplier associated with the meeting priority level to produce an adjusted usefulness value, normalize the adjusted usefulness value to be within the value range, and use the normalized adjusted usefulness value to compute the meeting score.

In other examples, the inference engine is further configured to identify an organizational role of the meeting organizer, multiply the usefulness value with a role multiplier associated with the organizational role of the meeting organizer to produce an adjusted usefulness value, normalize the adjusted usefulness value to be within the value range, and use the normalized adjusted usefulness value to compute the meeting score. The inference engine is further configured to identify an Organizational role of other meeting attendee, multiply the usefulness value with a role multiplier associated with the role of the other meeting attendee to produce an adjusted usefulness value, normalize the adjusted usefulness value to be within the value range, and use the normalized adjusted usefulness value to compute the meeting score.

In further examples, the inference engine is further configured to generate an attendance multiplier by dividing an attendee number the meeting with an invitee number of the meeting, multiply the meeting score with the attendance multiplier to produce an adjusted meeting score, and update a stored value of the meeting score with the adjusted meeting score. The inference engine is further configured to receive a request to generate a new meeting from the meeting organizer, retrieve the meeting score associated with the meeting organizer, generate the new meeting, and provide the new meeting with the meeting score to a new meeting attendee.

In some examples, a method executed on a computing device to optimize a meeting based on an organizer rating is described. The method includes transmitting a first request to a first meeting attendee to rate a meeting organizer for an evaluation of a usefulness of a meeting, transmitting a second request to a second meeting attendee to rate the meeting organizer for another evaluation of the usefulness of the meeting, receiving a first usefulness value associated with the meeting from the first meeting attendee, receiving a second usefulness value associated with the meeting from the second meeting attendee, computing a meeting score from the first usefulness value and the second usefulness value, and storing the meeting score in an association with the meeting organizer.

In other examples, the method further includes granting one or more of a group and an organization associated with the meeting organizer, an access to the meeting score. The method further includes monitoring a duration associated with the first usefulness value, detecting an expiration of the duration, re-computing the meeting score from the second usefulness value, and updating a stored value of the meeting score with the re-computed meeting score.

In further examples, the method further includes monitoring a duration associated with the first usefulness value, detecting an expiration of the duration, transmitting a new request to a new meeting attendee to rate the meeting organizer to quantify other usefulness of a new meeting, and receiving a new usefulness value from the new meeting attendee. The method further includes re-computing the meeting score by averaging the second usefulness value and the new usefulness value and updating a stored value of the meeting score with the re-computed meeting score. The method further includes receiving a request to generate a new meeting from the meeting organizer, analyzing a meeting invitee to identify a meeting score threshold associated with the meeting invitee, detecting the meeting score of the meeting organizer fail to exceed the meeting score threshold, and excluding the meeting invitee from a meeting invitation of the new meeting.

In some examples, a computer-readable memory device with instructions stored thereon to optimize a meeting based on an organizer rating is described. The instructions includes actions similar to the actions of the method. The instructions further include identifying an organizational role of the meeting organizer and adjusting the value range with a role multiplier associated with the organization role of the meeting organizer.

In other examples, the instructions further include monitoring a duration associated with the initial usefulness value, detecting an expiration of the duration, transmitting other new request to other new meeting attendee to rate the meeting organizer to quantify the usefulness of the new meeting, where the other new request includes the value range from which to select other new usefulness value, receiving the other new usefulness value from the other meeting attendee, re-computing the meeting score by averaging the new usefulness value and the other new usefulness value, and updating a stored value of the meeting score with the re-computed meeting score.

In some examples, a means for optimizing a meeting based on an organizer rating is described. The means for optimizing a meeting based on an organizer rating includes a means for transmitting a request to a meeting attendee to rate a meeting organizer for an evaluation of a usefulness of the meeting, a means for receiving a usefulness value associated with the meeting from the meeting attendee, a means for computing a meeting score from the usefulness value, and a means for storing the meeting score in an association with the meeting organizer.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A physical server to optimize a meeting based on an organizer rating, the physical server comprising:
a communication module configured to facilitate exchange of information associated with the meeting and other data with computing devices;
a memory configured to store instructions associated with a productivity service;
a processor coupled to the memory and the communication module, the processor executing the productivity service in conjunction with the instructions stored in the memory, wherein the productivity service includes:
an inference engine configured to:
transmit, through the communication module, a request to a meeting attendee to rate a meeting organizer for an evaluation of a usefulness of the meeting;
receive, through the communication module, a usefulness value associated with the meeting from the meeting attendee;
compute a meeting score from the usefulness value; and
store the meeting score in an association with the meeting organizer.

2. The physical server of claim 1, wherein the inference engine is further configured to:
transmit, through the communication module, other request to other meeting attendee to rate the meeting organizer for another evaluation of the usefulness of the meeting; and
receive, through the communication module, other usefulness value from the other meeting attendee.

3. The physical server of claim 2, wherein the inference engine is further configured to:
re-compute the meeting score by averaging the usefulness value and the other usefulness value; and
update a stored value of the meeting score with the re-computed meeting score.

4. The physical server of claim 1, wherein the inference engine is further configured to:
transmit, through the communication module, a new request to a new meeting attendee to rate the meeting organizer to evaluate another usefulness of a new meeting; and
receive, through the communication module, a new usefulness value from the new meeting attendee.

5. The physical server of claim 4, wherein the inference engine is further configured to:
re-compute the meeting score by averaging the usefulness value and the new usefulness value; and
update a stored value of the meeting score with the re-computed meeting score.

6. The physical sever of claim 1, wherein the inference engine is further configured to:
provide a value range within the request to the meeting attendee from which to select the usefulness value.

7. The physical server of claim 6, wherein the inference engine is further configured to:
identify a meeting priority level associated with the meeting;
multiply the usefulness value with a priority multiplier associated with the meeting priority level to produce an adjusted usefulness value;
normalize the adjusted usefulness value to be within the value range; and
use the normalized adjusted usefulness value to compute the meeting score.

8. The physical server of claim 6, wherein the inference engine is further configured to:
identify an organizational role of the meeting organizer;
multiply the usefulness value with a role multiplier associated with the organizational role of the meeting organizer to produce an adjusted usefulness value;
normalize the adjusted usefulness value to be within the value range; and
use the normalized adjusted usefulness value to compute the meeting score.

9. The physical server of claim 6, wherein the inference engine is further configured to:
identify an organizational role of other meeting attendee;
multiply the usefulness value with a role multiplier associated with the role of the other meeting attendee to produce an adjusted usefulness value;
normalize the adjusted usefulness value to be within the value range; and
use the normalized adjusted usefulness value to compute the meeting score.

10. The physical server of claim 1, wherein the inference engine is further configured to:
generate an attendance multiplier by dividing an attendee number of the meeting with an invitee number of the meeting;
multiply the meeting score with the attendance multiplier to produce an adjusted meeting score; and
update a stored value of the meeting score with the adjusted meeting score.

11. The physical server of claim 1, wherein the inference engine is further configured to:
receive a request to generate a new meeting from the meeting organizer;
retrieve the meeting score associated with the meeting organizer;
generate the new meeting; and
provide the new meeting with the meeting score to a new meeting attendee.

12. A method executed on a computing device to optimize a meeting based on an organizer rating, the method comprising:
transmitting a first request to a first meeting attendee to rate a meeting organizer for an evaluation of a usefulness of a meeting;
transmitting a second request to a second meeting attendee to rate the meeting organizer for another evaluation of the usefulness of the meeting;
receiving a first usefulness value associated with the meeting from the first meeting attendee;
receiving a second usefulness value associated with the meeting from the second meeting attendee;
computing a meeting score from the first usefulness value and the second usefulness value; and
staring the meeting score in an association with the meeting organizer.

13. The method of claim 12, further comprising:
granting one or more of a group and an organization associated with the meeting organizer an access to the meeting score.

14. The method of claim 12, further comprising:
monitoring a duration associated with the first usefulness value;
detecting an expiration of the duration;
re-computing the meeting score from the second usefulness value; and
updating a stored value of the meeting score with the re-computed meeting score.

15. The method of claim 12, further comprising:
monitoring a duration associated with the first usefulness value;
detecting an expiration of the duration;
transmitting a new request to a new meeting attendee to rate the meeting organizer to quantify other usefulness of a new meeting; and
receiving a new usefulness value from the new meeting attendee.

16. The method of claim 15, further comprising:
re-computing the meeting score by averaging the second usefulness value and the new usefulness value; and
updating a stored value of the meeting score with the re-computed meeting score.

17. The method of claim 1, further comprising:
receiving a request to generate a new meeting from the meeting organizer;
analyzing a meeting invitee to identify a meeting score threshold associated with the meeting invitee;
detecting the meeting score of the meeting organizer fail to exceed the meeting score threshold; and
excluding the meeting invitee from a meeting invitation of the new meeting.

18. A computer-readable memory device with instructions stored thereon to optimize a meeting based on an organizer rating, the instructions comprising:
transmitting an initial request to an initial meeting attendee to rate a meeting organizer for an evaluation a usefulness of an initial meeting, wherein the initial request includes a value range from which to select an initial usefulness value;
transmitting a new request to a new meeting attendee to rate the meeting organizer for another evaluation of a usefulness of a new meeting, wherein the new request includes the value range from which to select a new usefulness value;
receiving the initial usefulness value associated with the initial meeting from the initial meeting attendee;
receiving the new usefulness value associated with the new meeting from the new meeting attendee;
computing a meeting score from the initial usefulness value and the new usefulness value; and
storing the meeting score in an association with the meeting organizer.

19. The computer-readable memory device of claim 18, wherein the instructions further comprise:
identifying an organizational role of the meeting organizer; and
adjusting the value range with a role multiplier associated with the organization role of the meeting organizer.

20. The computer-readable memory device of claim 18, wherein the instructions further comprise:
monitoring a duration associated with the initial usefulness value;
detecting an expiration of the duration;
transmitting other new request to other new meeting attendee to rate the meeting organizer to quantify the usefulness of the new meeting, wherein the other new request includes the value range from which to select other new usefulness value;
receiving the other new usefulness value from the other new meeting attendee;
re-computing the meeting score by averaging the new usefulness value and the other new usefulness value; and
updating a stored value of the meeting score with the re-computed meeting score.
